(19) United States
(12) Patent Application Publication
(10) Pub. No.: US 2007/0123235 A1
(43) Pub. Date: May 31, 2007

(54) Apparatus and method for providing contact number recommendations to users of telephony devices

(75) Inventors: William T. Newport, Rochester, MN (US); John J. Stecher, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/290,884

(22) Filed: Nov. 30, 2005

(51) Int. Cl. H04M 3/493; H04M 3/42; H04Q 7/22

(52) U.S. Cl. 455/414.2

(57) ABSTRACT

Method and apparatus for providing information services to telephony devices. In one embodiment, a telephony device transmits a request for telephone numbers related to a provided telephone number. A service provider looks up related telephone numbers and provided the related telephone numbers to the requesting telephony device. The provided telephone number and the related telephone numbers may be related by being associated with the same or similar type of business. In one embodiment, the information services are fee-based.

### BACKGROUND OF THE INVENTION

1. Field of the Invention

The present invention generally relates to data processing, and more particularly, to a method, system and article of manufacture for providing users with call options in telephonic communication environments.

2. Description of the Related Art

Telephony devices are pervasive. Many people have a telephone for business, a telephone for home, and a mobile (e.g., cellular) telephone. In addition, service providers provide telephone service through computers.

One of the problems users of telephony devices are faced with (particularly users of mobile telephones) is locating relevant telephone numbers. Conventionally, users of landline phones simply open a telephone book and manually identify the numbers of interest. In the case of a user trying to locate a number(s) for a particular category of business, rather than a particular phone number for a particular business, the user can visually traverse the listings for, say, plumbers or pizzerias. The user can then call one or more of the numbers in the list of related numbers of a given business category. However, this is not always a possible or convenient method of looking up numbers. For example, users of cell phones do not typically have access to a physical phone book, which are usually cumbersome due to their size and weight. Even landline users may not have access to a phonebook, or at least not to an up-to-date phonebook. Accordingly, users often turn to other options for looking up numbers such as calling an information service or accessing the Internet. However, information services typically provide a limited number of phone numbers per call, and accessing the Internet is often time consuming due to bandwidth limitations and the need to navigate through many sites to find the desired information.

Accordingly, what is needed is a telecommunication system facilitating number lookup.

### SUMMARY OF THE INVENTION

Embodiments of the present invention provide methods and systems for providing information services to telephony devices. In one embodiment, a computer-implemented method for looking up related telephone numbers includes receiving a request initiated by a client telephony device, the request including a telephone number input at and transmitted by the client telephony device; the request being received by a service provider providing fee-based telephony services for a user of the client telephony device. The service provider then looks up one or more related telephone numbers for the telephone number provided by the client telephony device. The related telephone numbers are returned to the client telephony device.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

Note, however, that the appended drawings illustrate only typical embodiments of this invention and are therefore do not limit the scope thereof, for the invention may admit to other equally effective embodiments.

FIGS. 1A-1D illustrate functional views of telecommunication networks in which embodiments of the present invention may be implemented.

FIG. 2 illustrates a view of components of a mobile telephone, according to one embodiment of the invention.

FIG. 3 illustrates a method of providing related telephone numbers in response to a given user input, according to one embodiment of the invention.

FIGS. 4A-C show a series of screens illustrating a request for related telephone numbers, and a corresponding response, according to one embodiment of the invention.

### DETAILED DESCRIPTION OF THE PREFERRED EMBODIMENTS

The present invention provides methods and systems for providing information services to telephony devices. In one embodiment, a telephony device transmits a request for telephone numbers related to a provided telephone number. A service provider looks up related telephone numbers and provided the related telephone numbers to the requesting telephony device. The provided telephone number and the related telephone numbers may be related by being associated with the same or similar type of business. In one embodiment, the information services are fee-based.

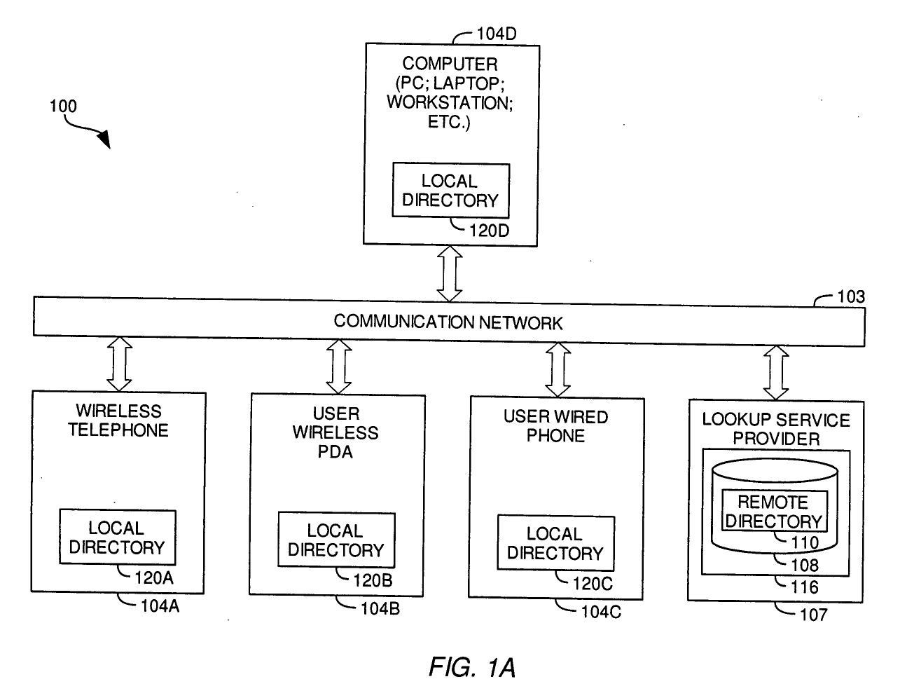

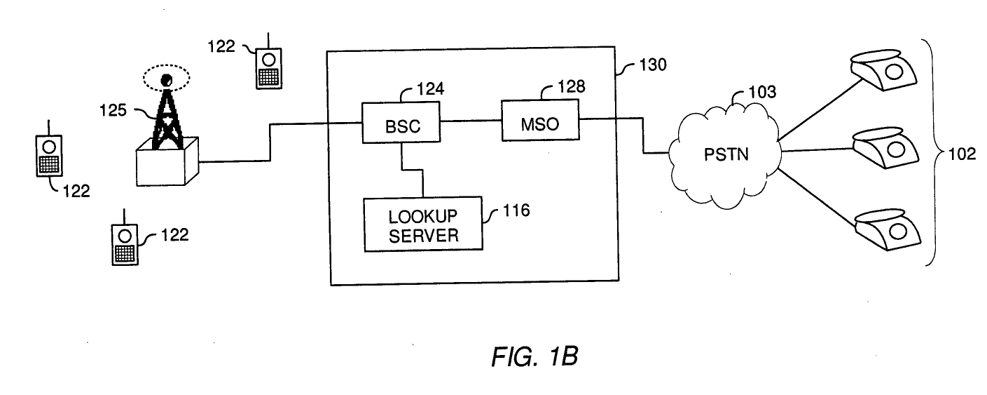

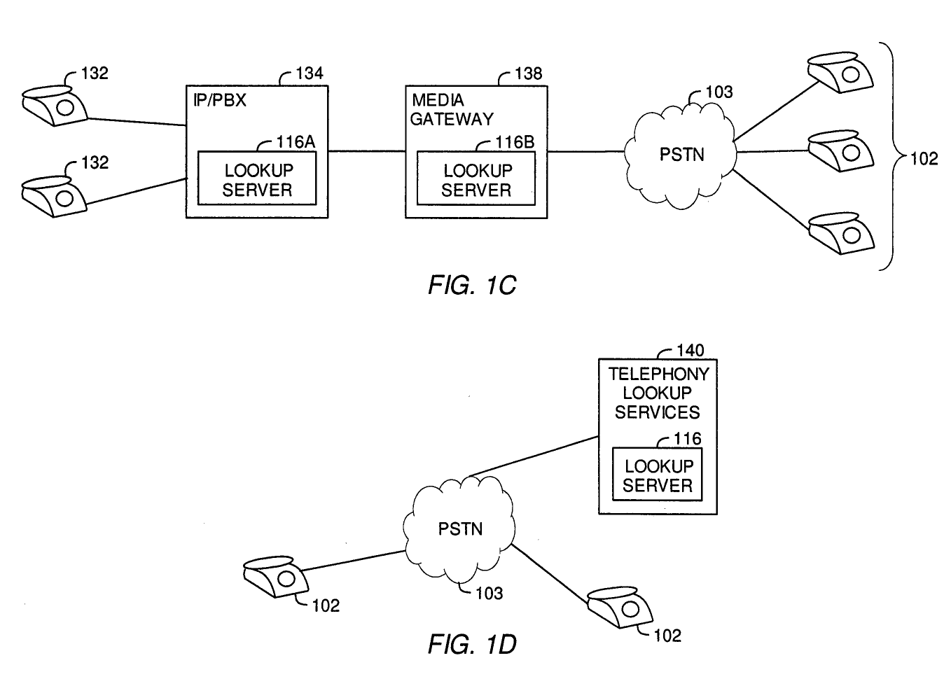

One embodiment of the invention is implemented as a program product for use with a computer system such as, for example, the telecommunication architectures illustrated in FIG. 1 and described below. The programs of the program product define functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are typically comprised of variables and data structures that either reside locally to the program or are found in memory or on storage devices. Modern telephony devices, such as a mobile phone or voice over internet protocol (VoIP) enabled telephone may contain a processor and memory, and accordingly, embodiments of the present invention may be implemented to run on the telephone device directly. Alternatively, software components may be configured to communicate with a telephony server maintained by a telecommunications service provider, e.g., the business providing a subscriber with mobile phone service may choose to provide services to its subscribers for an additional fee.

In addition, various programs described below may be identified based upon the application for which they are implemented in a specific embodiment of the invention. However, it should be appreciated that any particular program nomenclature that follows is used merely for convenience, and thus, the invention should not be limited to use solely in any specific application identified or implied by such nomenclature.

FIG. 1A is an illustrative network environment 100. In general, the network environment 100 includes a communications network 103, a plurality of telephony devices 104A-D (collectively referred to as “telephony devices 104”) and a network (“lookup”) server 116. The communications network 103 may be any system or combination of systems configured to allow communication between the telephony devices 104 themselves, and between the telephony devices 104 and the network server 116. Illustratively, the communications network 103 may be configured for digital cellular (including PCS (personal communications services)), cellular (whether analog or digital), Cellular Digital Packet Data, Cellular Digital Packet Data, Global System for Mobile Communication and the like. The communications network 103 may also be a plain old telephone system (POTS). In a particular embodiment, the communications network 103 is a public packet data network, such as the Internet.

The telephony devices 104 may be any kind of wireless or wired communication devices capable of establishing a connection with the communications network 103. Although the telephony devices 104 are shown connected to an apparently singular communications network 103, the communications network 103 is in fact representative of one or more networks. As such, the telephony devices 104 may each be configured to communicate with the communications network 103 using different communications protocols. In the case where the communications network 103 is the Internet, the telephony devices 104 are enabled with Voice-over-IP (VoIP) telephony.

By way of illustration, the telephony devices shown in FIG. 1 include a wireless telephone 104A, a wireless personal digital assistant 104B (PDA), a land-based wired telephone 104C and a computer 104D. The wireless telephone 104A may include long range devices such as a digital or analog mobile telephones and may also include short range devices such as wireless telephones for household use. The PDA 104B (also called Personal Communication Device (PCD) and Personal Intelligent Communicator (PIC)) may comprise commercially available PDA devices such as the 3Com Palm, the Casio Casiopeia and the Hewlett Packard Jornada. The PDA 104B may use operating systems such the Palm Pilot™, the Windows CE™ and the Handspring Visor™. The computer 104D represents any other computerized device such as a PC, laptop, workstation, etc., capable of sustaining data communications (and particularly voice communications) with the network 103.

FIGS. 1B-1D show more particular examples of telecommunication environments that are generally illustrated by FIG. 1A. Note, however, that these examples are meant to be merely illustrative of telecommunication environments that provide a framework for embodiments of the present invention, and should not, therefore, be considered in any way to limit the invention to the illustrated environments.

FIG. 1B illustrates a typical telecommunications architecture connecting mobile telephones 122 (e.g., an instance of the wireless telephony device 104A) to the PSTN 103. PSTN is an acronym for Public Switched Telephone Network. Generally, the PSTN 103 comprises the world's public circuit-switched telephone networks, in much the same way that the Internet is the collection of the world's public IP-based packet-switched networks. Originally a network of fixed-line analog telephone systems, the PSTN 103 is now an almost entirely digital system that routes calls from mobile as well as fixed telephones. Mobile phones 122 communicate with a plurality of base transceiver stations (BTS) 125 that act as a transmitting and receiving link. That is, the BTS 125 is the device that actually communicates with the mobile phone 122 using radio waves (e.g., GSM-based mobile phones may use the 900 MHz and 1800 MHz frequency bands). The BTS 125 connects to a base station controller BSC 124 over a high bandwidth communication line (e.g., a T1/E1 line). The BSC 124 and BTS 125 form the link between wireless devices and the “wireline” telephone network. Behind this connection, a mobile telephone switching office (MSO) 128 connects the BSC to the PSTN 103, and ultimately, other communication endpoints 102 (which may be, e.g., any of the telephony devices 104 described above with respect to FIG. 1A). In one embodiment, the endpoints 102 may be any entity with a phone number capable of being dialed from mobile phone 122. Within this general framework, embodiments of the present invention allow a mobile service provider 130 supplying the mobile telephone architecture (e.g., the BTS 125, BSC 124, and MSO 128) to provide telephonic services. In one embodiment, a telephony lookup server 116 is integrated with the service provider's telecommunication components and may be configured to provide provides the lookup services of the present invention in response to data received from the caller's telephony device (the mobile device 122). In another embodiment, the mobile device 122 may contain the program products to create, store and manage the lookup feature of the present invention.

FIG. 1C illustrates an embodiment of a voice over internet protocol (VoIP) network telephone network connected to the PSTN. VoIP systems use packet switching networks, like the internet, to exchange the audio portion of a telephone conversation just as any other data transferred across the network (e.g., email, WebPages, and the like). A VoIP enabled telephone 132 (e.g., an instance of the wireless telephony device 104A) is used to place and receive telephone calls in the same manner as a conventional telephone. In one embodiment, The VoIP telephone 132 is connected to an IP (internet protocol) based PBX 134. “PBX” (or private branch exchange) refers to a privately-owned telephone switch that provides an access point to a media gateway 138 and the PSTN 103. The IP/PBX 134 may be configured to include a telephony lookup server 116A that provides the lookup services of the present invention. Media gateway 138 is used to interconvert the VoIP packet switched data (e.g., IP datagram packets) with the PSTN network (e.g., SS7 data) 103. The media gateway 138 may also (or alternatively) include a lookup server 116B.

FIG. 1D illustrates two communication endpoints 102 (e.g., any of the types of telephony device 104 described above with respect to FIG. 1A) connected to the PSTN 103. Also connected to the PSTN is a lookup service 140 that includes a lookup sever 116. In one embodiment, a subscriber contacts, and receives lookup services from, the telephony lookup service 140 according to embodiments described in more detail below.

Again, note that FIGS. 1A-1D illustrate embodiments of the invention that include general components of telecommunications networks. Also note that FIGS. 1A-1D each includes the PSTN 103. Thus, any communication endpoint (e.g., standard telephones, mobile phones, VoIP enabled phones, and the like) connected to the PSTN may contact another communications endpoints. More generally, although illustrated separately the various networks illustrated in FIGS. 1A-1D may be interconnected with each other though the PSTN. For example, an individual using a mobile telephone 122 (from FIG. 1B) may call a telephone number that connects to a VoIP enabled telephone 132 (from FIG. 1C). In any case, the networks of FIGS. 1A-1D are merely illustrative.

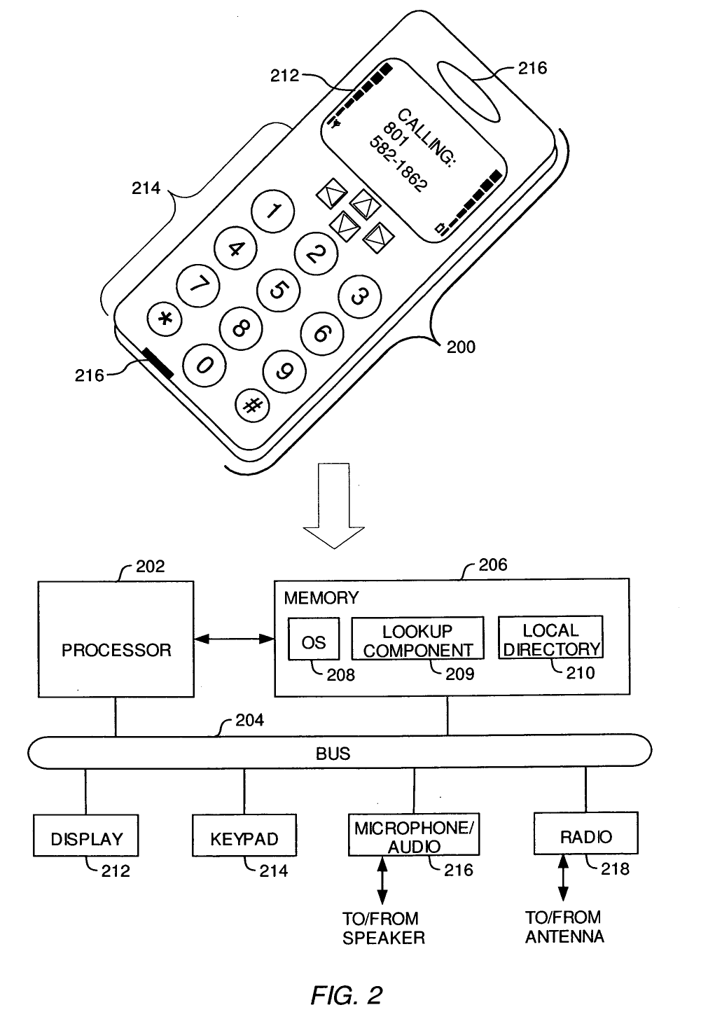

Referring now to FIG. 2 a mobile telephony device 200 (e.g., a wireless telephone 104A or wireless PDA 104B, both shown in FIG. 1A) configured according to one embodiment of the present invention is illustrated. A processor 202 is connected to a bus 204 and a memory 206. The memory 206 stores an operating system 208, a lookup component 209 and a local directory 210. Although not shown, the device 200 may include any other data and programming in memory, including an address book, a calendar, games, etc. Also connected to the bus 204, is a display panel 212 used to display information. The display panel 212 provides a viewing area which may display information to a user. For example, the display panel 212 may display a number dialed, a name of the entity associated with the number (herein referred to as the “callee”), a counter indicating a duration of a call, battery power levels, etc. A keypad 214 is used to enter phone numbers, navigate through menus displayed on the display panel, and to select lookup functions of the present invention. In one embodiment, the keypad may be replaced with or work in tandem with, voice recognition technology. The device 200 also includes microphone and audio components 216 connected to a speaker and radio components to transmit and receive radio signals to/from other remote components such as, e.g., the BTS 125.

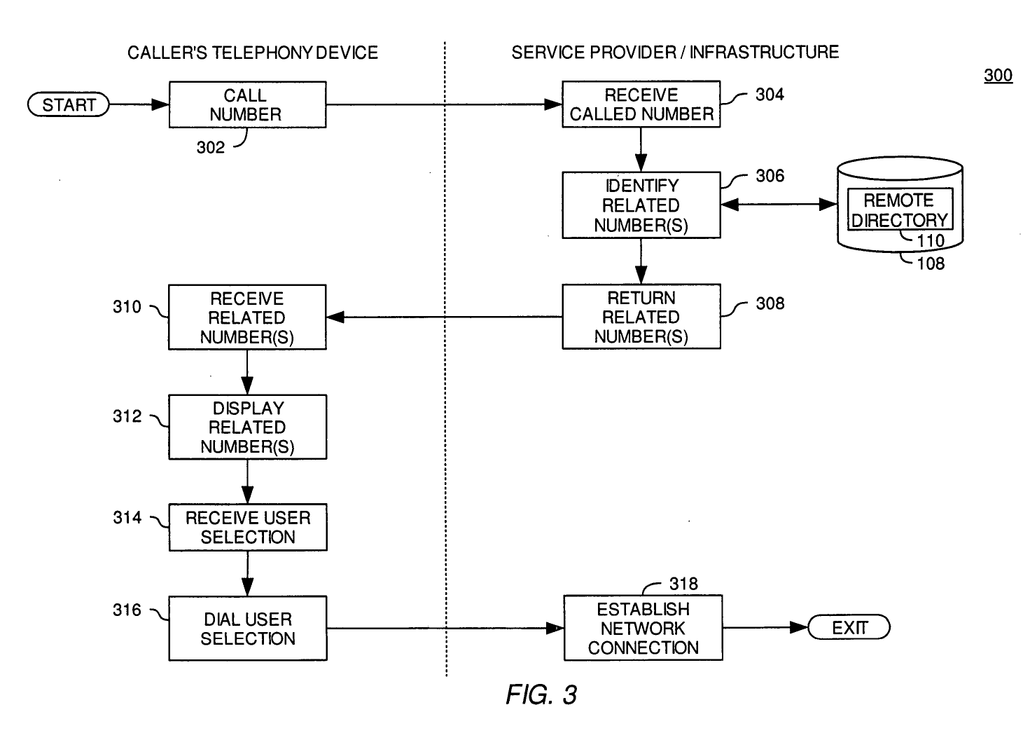

Generally, embodiments of the invention provide a user with a lookup function that facilitates locating similar businesses. Referring now to FIG. 3, a flow chart is show illustrating a method 300 according to one embodiment of the present invention is shown. A left-hand side of FIG. 3 illustrates functionality of a telephony device, such as any of the telephony devices described with respect to FIGS. 1A-1D. A right-hand side of FIG. 3 illustrates functionality of a service provider and communication network infrastructure. For purposes of illustration only, the telephony device referred to in describing FIG. 3, is the mobile telephone 200 of FIG. 2. At step 302, a user of the telephony device initiates a call by inputting and transmitting a number. The number is provided to the lookup sever 116 (directly or via intermediary processing components) and upon receiving the transmitted number (step 304), the lookup sever 116 is configured to identify one or more related numbers (step 306). In one embodiment, the lookup sever 116 accesses a directory (e.g., the remote directory 110 show in FIG. 1A) to locate the related numbers. The numbers may be related, for example, according to being categorized by business groups. Thus, numbers of pizzerias may be categorized in a common group in the remote directory 110. Likewise, numbers of dry cleaners may be in a separate categorical group in the remote directory 110. Further, the lookup sever 116 may be configured to select only those numbers in a given category that are proximate to the user's location.

In one embodiment, the lookup sever 116 initiates the lookup in response to first detecting that the transmitted number is a business number. Alternatively, the lookup sever 116 indexes into the remote server 110 using the transmitted number without first detecting whether the transmitted number is a business number. In any case, the related numbers (if any) are then returned to the telephony device (step 308).

The telephony device receives the related numbers provided by the service provider (step 310), and then displays the numbers on a display screen (e.g., display screen 212) of the device (step 312). The user may then use an appropriate input component (e.g., the keypad 214) to select a desired number from the displayed list of numbers (step 314). The selection may be one of the related numbers returned by the service provider, or may be the original input number. The user's telephony device then dials the selected number (step 316) in an attempt to establish a network connection with another telephony device receiving calls at the selected number (step 318). It is noted that the service used to ultimately establish a network connection (at step 318) may or may not be the same as the service provider of the lookup function (at steps 304-308).

It is contemplated that the call (at step 302) may be initiated by explicitly dialing the input number, e.g., inputting the number using a key pad 214 of the mobile phone 200 and then pressing a transmit button (e.g., “send”). In order to invoke the lookup function the telephony device may first need to be placed in a special mode (lookup enabled). In such a mode, the telephony device may transmit, with the dialed number, a command code recognizable by the service provider and which configures the service provider to perform the lookup function.

Alternatively, it is contemplated that the telephony device is configured with a special purpose button (or other selectable feature such as a menu item) which, when selected, bypasses dialing the input number, and instead transmits the input number to the lookup sever 116 for the particular purpose of performing the lookup function and locating related numbers.

In one embodiment described above identifying related numbers requires establishing a network connection with the service provider and accessing the remote directory 110. However, in another embodiment, related numbers may be stored on the user's client telephony device (e.g., on the mobile telephone 200). Accordingly, FIG. 1 shows the telephony devices 104A-D configured with a local directory 120A-D, respectively. Is contemplated, for example, that the local directory contains at least those telephone numbers likely to be called by the user. For example, the local directory may contain those numbers in the same area code as the user. The local directory may also be customized to the particular user according to profile information provided by the user to the service provider, whereby the service provider can identify those numbers most likely to be called by the user. Is also contemplated that the local directory is periodically updated. In another embodiment, the local directory caches related telephone numbers previously received from the remote directory 110. Regardless of how the local directory is populated and maintained, it is contemplated that when the user requests related numbers the local directory is accessed first. Any related numbers identified from the local directory are then displayed to the user. If the local directory contains no related numbers, or if the user specifies that any numbers returned from a local directory are unsatisfactory, then a network connection is established in order to invoke the lookup server 116.

As note above, the lookup sever 116 may be configured to select only those numbers in a given category that are proximate to the user's location. This may be accomplished for example using GPS technology such as when the user's telephony device is GPS-enabled (although any other location-determining technology is contemplated). In this case, the user's position may be sent along with the input number at step 302. The user's position may then be used by the lookup server 116 to identify only those numbers with a predetermined distance from the user (e.g., 10 miles). The predetermined distance may be user-selectable and may also have been transmitted at step 302, or may be separately transmitted, or may be set by the service provider. It is further contemplated that the related numbers returned to the user may be ranked according to proximity to the user and, in one embodiment, the distance from the user of f the business corresponding to each related number may be displayed next to the number on the display screen at step 316.

The numbers may also be ranked according to statistical data. For example, the service provider may determine the frequency with which related numbers provided to users of the lookup function are selected. These frequencies can then be used to rank the list, with the most frequently called number being listed first (descending list).

The numbers may also be ranked according to user profile information. That is, the service provider may maintain a profile for each of its respective users (or at least those desiring to use to lookup function). Each profile may describe various preferences of the respective users, e.g., based on user-provided information or based on historical information gathered by the service provider (or some third-party). The historical information may describe, for example, the user's behavior while navigating the Web and/or previous lookup selections made by the user. Applying the profile information service provider may be able to rank any related numbers displayed to the user in an order that is most likely representative of the user's own preferences.

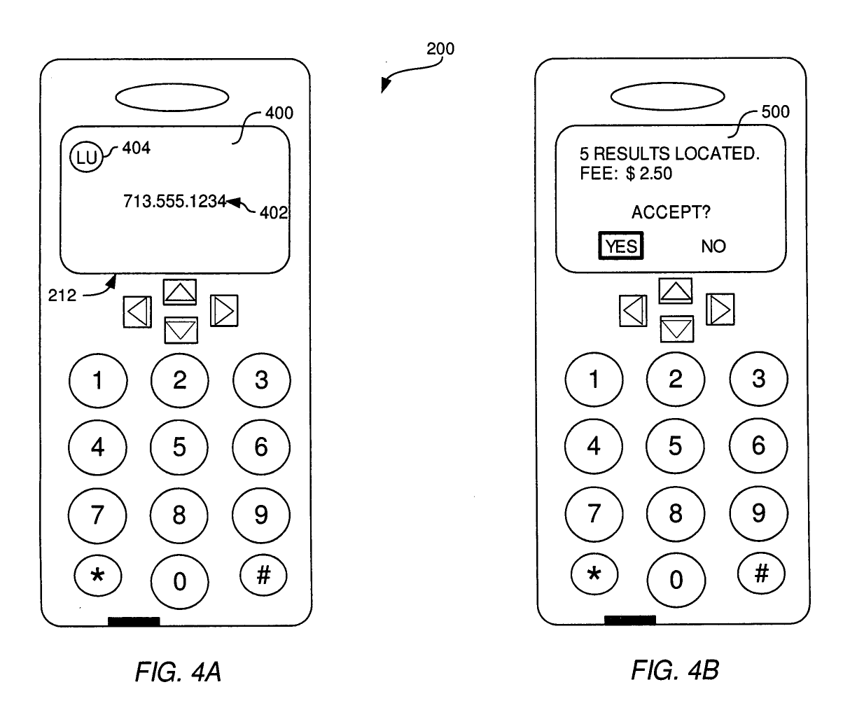

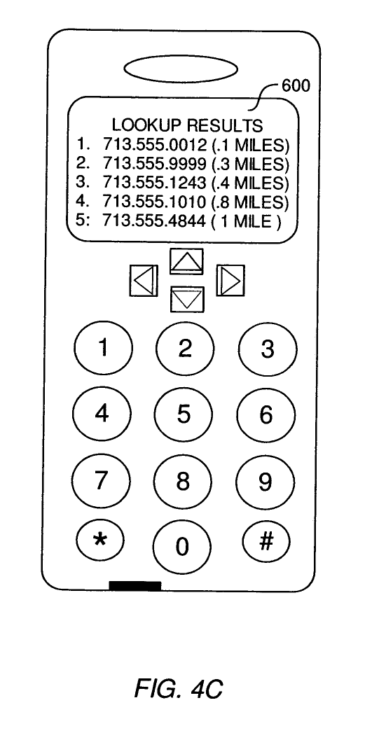

FIGS. 4A-C show a series of representative output screens of the display screen 212. FIG. 4A shows an input screen 400 in which the user inputs a number 402 for which the user desires to see related numbers. An icon 404 in the corner of the screen indicates the user has place the phone in the lookup enabled mode, so that the inputted number will not be dialed when the user presses the “send” button, but rather will be provided to the service provider as a request to invoke the lookup sever 116 and perform the number lookup function. After the number 402 is transmitted, the server 116 looks up related numbers and (in one embodiment) calculates a fee to view the numbers. FIG. 4B shows a prompt screen 500 prompting the user to accept the charges for viewing the related numbers. If the user accepts (e.g., by highlighting and selecting “Yes” using the appropriate buttons of the keypad 214), the related numbers are displayed on an output screen 600 as shown in FIG. 4C. Illustratively, the related numbers are ranked according to distance from the user (i.e., the user's telephone device) as shown by the relative distances shown in the parentheticals next to the respective numbers. The user can then highlight a desired number and press “send” to call the selected number. It is also contemplated that the results page (i.e., the output screen 600) can be saved so that the user can retrieve the page later to dial one of the other related numbers without performing the lookup function again. It is also contemplated that the numbers displayed on the results page may include the respective business name next to each number. It is further contemplated that forms of advertisement may be associated with one or more of the numbers displayed on the results page. For example, the telephone number of a pizzeria may have the statement, “Best Pizza in Town”, displayed next to their number.

It is also contemplated that the service provider may derive fees from the lookup service. Generally, the service provider may derive fees from both business owners who wish to have their telephone numbers included in the directories and/or from users who used to lookup function on client devices. For example, the service provider may charge business owners a periodic subscription fee for maintaining their respective numbers in the lookup directories. It is also contemplated that business owners may be charged a premium in order to affect a more desirable ranking of their respective numbers. In other words, by paying a premium a business owner may be able to increase the probability that their number will be returned to a requesting user, or increase the probability that their number will be ranked higher than others returned to a requesting user. As noted above, it is contemplated that the numbers displayed on the results page may include the respective business name next to each number. In one embodiment, displaying the business name may be a premium service option that either (or both) the business owner or the user pay an additional fee for. Forms of advertisement (such as the one described above regarding the pizzeria) may also be purchased by the business owners.

In addition, or alternatively, the service provider may charge the users a fee(s) for providing the lookup function service. In one embodiment, the user is charged a per use fee for the service. That is, the user incurs a fee each time he/she invokes the lookup server 116 to provide related numbers. The fee may be a flat fee or may be dependent upon how many related numbers are returned to the user. In the latter case, the user may first be prompted to accept the charges before the related numbers are displayed to the user (via the display screen 212).

It should be noted that while the lookup server 116 is described herein as having specific functions (in particular the lookup function), the server 116 may in fact be representative of a plurality of collaborating servers each configured to perform different functions. Such functions include accessing user profile information, calculating applicable fees, etc.

While the foregoing is directed to embodiments of the present invention, other and further embodiments of the invention may be devised without departing from the basic scope thereof, and the scope thereof is determined by the claims that follow.

What is claimed is:

1. A computer-implemented method for looking up related telephone numbers, comprising:
receiving a request initiated by a client telephony device, the request including a telephone number input at and transmitted by the client telephony device; the request being received by a service provider providing fee-based telephony services for a user of the client telephony device;
looking up, by the service provider, one or more related telephone numbers for the telephone number provided by the client telephony device; and
returning the related telephone numbers to the client telephony device.

2. The method of claim 1, further comprising, prior to returning the related telephone numbers, prompting the user to accept charges for viewing the related telephone numbers.

3. The method of claim 1, wherein the client telephony device is a mobile telephone and the service provider is a mobile telephone service provider.

4. The method of claim 1, wherein looking up the related telephone numbers is done on the basis of a determined geographic location of the client telephony device.

5. The method of claim 1, wherein the service provider is configured to select the related telephone numbers only from a group of telephone numbers in the same business as the telephone number provided by the client telephony device.

6. The method of claim 1, wherein the service provider is configured to initiate the lookup of the related telephone numbers only after determining that the telephone number provided by the client telephony device is a business telephone number; and wherein the related telephone numbers are selected only from a group of telephone numbers in the same business as the telephone number provided by the client telephony device.

7. The method of claim 1, wherein the client telephony device is a mobile telephone and the service provider is a mobile telephone service provider; wherein looking up the related telephone numbers is done on the basis of a determined geographic location of the client telephony device; wherein the service provider is configured to initiate the lookup of the related telephone numbers only after determining that the telephone number provided by the client telephony device is a business telephone number; and wherein the related telephone numbers are selected only from a group of telephone numbers in the same business as the telephone number provided by the client telephony device.

8. The method of claim 7, further comprising charging the user a fee for the lookup.

9. The method of claim 7, wherein the related telephone numbers are selected from a group of telephone numbers maintained by the service provider in a directory and further comprising charging a fee to each owner of a telephone number in the directory for having its respective telephone number maintained in the directory.

10. A computer-implemented method for requesting related telephone numbers, comprising:
receiving, at a mobile telephony device, a telephone number input by a user of the client telephony device;
transmitting, via a mobile telephone infrastructure, the telephone number to a service provider as a request for related telephone numbers without requesting establishment of a network connection with the telephone number; wherein the service provider provides fee-based telephony services for a user of the mobile telephony device;
receiving, by the mobile telephony device, a response to the request from the service provider; the response including one or more related telephone numbers determined by the service provider to be related to the transmitted telephone number; and
displaying the related telephone numbers on a display screen of the mobile telephony device.

11. The method of claim 10, further comprising receiving a user command to dial a selected one of the displayed related telephone numbers.

12. The method of claim 10, wherein the related telephone numbers provided to mobile telephony device by the service provider are retrieved by the service provider from a directory on the basis of proximity of the respective locations of business establishments corresponding to the related telephone numbers selected by the service provider.

13. The method of claim 10, wherein the mobile telephony device is first placed in a lookup mode prior to transmitting the telephone number to the service provider; wherein the lookup mode configures the mobile telephony device to transmit the telephone number as a lookup request, rather than a request to dial the transmitted number.

14. The method of claim 10, further comprising:
caching the related telephone numbers received from the service provider; and
indexing into the cached related telephone numbers using a user-provided telephone number to identify related telephone numbers from the cached telephone numbers.

15. A computer system, comprising:
a directory stored on a storage device and containing telephone numbers;
a lookup server comprising at least a process and configured to perform a lookup function in response to receiving requests initiated by client telephony devices, each request including a telephone number input at and transmitted by the respective client telephony device; wherein the lookup server is maintained by a service provider providing fee-based telephony services for a user of the client telephony device; wherein the lookup function performed by the server in response to receiving a given telephone number from a given client telephony device comprises:
looking up, in the directory, one or more related telephone numbers for the telephone number provided by the client telephony device; and
returning the related telephone numbers to the client telephony device for a fee.

16. The computer system of claim 15, wherein the lookup function further comprises, prior to returning the related telephone numbers, prompting the user to accept charges for viewing the related telephone numbers.

17. The computer system of claim 15, wherein the client telephony device is a mobile telephone and the service provider is a mobile telephone service provider.

18. The computer system of claim 15, wherein looking up the related telephone numbers is done on the basis of a determined geographic location of the client telephony device.

19. The computer system of claim 15, wherein the service provider is configured to select the related telephone numbers from the directory only from a group of telephone numbers in the same business as the telephone number provided by the client telephony device.

20. The computer system of claim 15, wherein the service provider is configured to initiate the lookup of the related telephone numbers only after determining that the telephone number provided by the client telephony device is a business telephone number; and wherein the related telephone numbers are selected only from a group of telephone numbers in the same business as the telephone number provided by the client telephony device.
